(19) United States
(12) Patent Application Publication
(10) Pub. No.: US 2022/0412299 A1
(43) Pub. Date: Dec. 29, 2022

(54) FUEL CONDUIT CONNECTION ASSEMBLY FOR A VEHICLE

(71) Applicant: VOLVO TRUCK CORPORATION, Goteborg (SE)

(72) Inventors: Jeffrey DENIAN, Goteborg (SE); Christian Dansund, Goteborg (SE)

(73) Assignee: VOLVO TRUCK CORPORATION, Goteborg (SE)

(21) Appl. No.: 17/808,203

(22) Filed: Jun. 22, 2022

(30) Foreign Application Priority Data
Jun. 29, 2021 (EP) 21182518.7

(51) Int. Cl. F02M 63/02; F02M 55/00; F02M 55/02

(52) U.S. Cl. CPC F02M 63/0275; F02M 55/004; F02M 55/025

(57) ABSTRACT

A fuel conduit connection assembly for interconnecting fuel system components of an internal combustion engine (ICE) system. The fuel conduit connection assembly includes a mounting structure for fastening a portion of the assembly to an ICE external structure; a fuel receiving conduit portion having a plurality of inlet fuel duct connections for connecting to a plurality of corresponding fuel channels of a fuel system component outside the ICE external structure, respectively; a single fuel feeding conduit portion for connecting to a fuel system component internal the ICE external structure; and a sealing arrangement arranged on an outer circumferential surface of the assembly and configured to provide sealing between a first environment and a second environment in an assembled state with the ICE external structure.

### TECHNICAL FIELD

The present disclosure relates to a fuel conduit connection assembly for interconnecting fuel system components of an internal combustion engine (ICE) system. Moreover, the present disclosure relates to a fuel system for an ICE system provided with such fuel conduit connection assembly, and to an ICE system provided with such fuel conduit connection assembly. The present disclosure may typically be applied in an ICE system used as a part of a driveline of heavy-duty vehicles, such as trucks, buses, and construction equipment. The present disclosure may likewise be applied in other vehicles such as cars and other light-weight vehicles etc., but also in marine vessels and the like. Other applications are also possible, such as the application of the present disclosure in a stationary power plant system.

### BACKGROUND

In the field of fuel systems and fuel injections systems, there is an increasing demand for improving the efficiency of supplying fuel, such as diesel to a plurality of injectors of an internal combustion engine of a vehicle. In some fuel systems, the ICE system comprises a fuel injection system in the form of a so-called common rail system, in particular for ICE systems where the fuel is directly injected to the cylinders of the ICE. These types of fuel injection systems may commonly be denoted as direct fuel injection systems.

A typical common rail system is fluidly connected to a high-pressure fuel pump delivering fuel via a high-pressure line to the common rail. The common rail is a form of an accumulator. The term common rail system is indicative of a fuel injection system in which there is a common rail which supplies multiple injectors with fuel. The common rail is configured to deliver fuel via a plurality of high-pressure pipes to multiple injectors. The system may for example comprise six injectors, six high pressure pipes, and one common rail (for a 6-cylinder engine).

In addition, the common rail system may comprise yokes to hold the injectors, brackets to hold the common rail, clamps to maintain the high-pressure pipes, sealings, etc. With the typical common rail system, notwithstanding the high-pressure pump, several parts need to be assembled in the engine assembly plant, which often is a time-consuming task for the personnel. Further, the overall fuel system may typically have a number of additional high-pressure joints that are considered potential leakages sources. By way of example, the fuel conduit between the common rail system arranged inside the ICE environment needs to be fluidly connected to e.g. the fuel pump, which is arranged outside the ICE environment. The fuel pump also needs to be fluidly connected to a fuel tank of the vehicle.

Furthermore, the installation of the complete fuel system into the ICE system may require significant space, partly caused by the required space of the individual parts, such as individual high pressure pipes and partly by the space reserved for tool access during assembly and services of the components making up the ICE system. These considerations also apply to aftermarket services.

For at least these reasons, it would be desirable to improve at least parts of the fuel supply system making up the fluid interface connection between the fuel pump and the common rail system of an ICE system.

### SUMMARY

An object of the disclosure is to provide an improved fuel interface connection for a fuel system of a vehicle internal combustion engine system, in which fuel system components arranged outside the internal combustion engine can be connected to a fuel system component arranged inside the internal combustion engine in a simple, yet reliable and user-friendly manner. The object is at least partly achieved by an assembly according to claim 1. The object is also achieved by the other independent claims. The dependent claims are directed to advantageous embodiments of the disclosure.

According to a first aspect of the disclosure, there is provided a fuel conduit connection assembly for interconnecting fuel system components of an internal combustion engine (ICE) system. The fuel conduit connection assembly comprises: a mounting structure for fastening a portion of the assembly to an ICE external structure; a fuel receiving conduit portion having a plurality of inlet fuel duct connections for connecting to a plurality of corresponding fuel channels of a fuel system component outside the ICE external structure, respectively; a single fuel feeding conduit portion for connecting to a fuel system component internal the ICE external structure; and a sealing arrangement arranged on an outer circumferential surface of the assembly and configured to provide sealing between a first environment and a second environment in an assembled state with the ICE external structure.

In this manner, there is provided an improved fuel conduit connection assembly capable of interconnecting a plurality of fuel components arranged outside the ICE with a fuel component arranged inside the ICE. In addition, when the fuel conduit connection assembly is arranged to an outside of the ICE structure, the assembly provides for a combined unit for penetration and interconnection of the ICE external and internal high-pressure pipes of the fuel system. By way of example, the fuel conduit connection assembly provides a single interface module for transporting a high-pressure fuel (e.g. 3000 bar) from a fuel pump system, arranged outside of the ICE, to a common rail system arranged inside of the ICE. As such, the fuel conduit connection assembly may be adapted to contain and deliver a high-pressure fuel from the fuel pump system to the injector bodies of the common rail system.

By the arrangement of the fuel conduit connection assembly, in particular by means of the arrangement of the mounting structure, the fuel receiving conduit portion and the single fuel feeding conduit portion, the assembly is configured to be attached to an external side of an ICE component, such as the engine block, the flywheel housing or the valve cover of the ICE, while extending therethrough from the external side to the internal side in a corresponding through hole, which may typically be designed to match the dimensions of the single fuel feeding conduit portion.

Moreover, by the fuel receiving conduit portion defining the inlet fuel duct connections and the single fuel feeding conduit portion, the fuel conduit connection assembly is configured to align at least two separate flow channels from the fuel pump into one single feed connection to the common rail system. Moreover, in contrast to some prior art system, the assembly provides for a minimum number of sealing surfaces between the inside (first) ICE environment and the outside (second) ICE environment.

By providing a fuel conduit connection assembly with a mounting structure, it becomes possible to secure the fuel conduit connection assembly to the ICE system in a robust and simple manner so as to ensure that the fuel conduit connection assembly can handle loads from any interconnecting internal and external high pressure conduit(s) and or pipe(s). Also, the mounting structure in combination with the sealing arrangement contribute to permit some individual movement between the interface components of the assembly.

To this end, the fuel conduit connection assembly provides a simple, yet compact and highly functional module for optimized installation in the ICE system environment.

By way of example, the ICE external structure may be an ICE component, including any one of the following: a flywheel housing, a valve cover, an engine block, or the like.

The sealing arrangement may contain a single sealing surface or a number of sealing surfaces, that collectively define the sealing.

Typically, the first environment refers to an inner ICE oil pressure environment, while the second environment refers to an outer ICE atmospheric pressure environment, i.e. an environment located outside the ICE. As such, the first and second environments are defined in relation to the sides of the ICE external structure.

Further, by providing the fuel receiving conduit portion and the single fuel feeding conduit portion with detachable interface connections, the assembly can be easily disconnected from the ICE internal and external fuel connecting components from both sides of the ICE. Hence, another advantage of the assembly is to allow for an improved service of the ICE and/or the fuel system. Typically, each one of the plurality of inlet fuel duct connections may comprise a corresponding end portion, respectively. In addition, each one of the corresponding end portions may be adapted to detachably connect to a corresponding fuel connection of the plurality of corresponding fuel channels. The plurality of corresponding fuel channels extends from the fuel pump (i.e. the external fuel system component outside the ICE external structure). By way of example, each one of the end portions is provided in the form of a threaded end portion. According to at least one example embodiment, the single fuel feeding conduit portion comprises an end portion adapted to detachably connect to a corresponding fuel connection of the inside ICE fuel system component. Typically, the end portion of the single fuel feeding conduit portion may be provided in the form of a threaded end portion.

According to at least one example embodiment, the fuel receiving conduit portion and the single fuel feeding conduit portion are configured to transport a high-pressure fuel. The high-pressure fuel receiving conduit portion and single fuel feeding conduit portion may for example be adapted to contain and transfer fuel having a pressure in the range of 200 to 3500 bar, in operation.

According to at least one example embodiment, the sealing arrangement comprises at least an O-ring arranged about the single fuel feeding conduit portion.

According to at least one example embodiment, the fuel conduit connection assembly further comprises a portion adapted to align a plurality of fuel flow receiving channels formed by the inlet fuel duct connections into a single fuel feed channel of the single fuel feeding conduit portion.

Optionally, the mounting structure may be arranged on the fuel receiving conduit portion for attachment to an outside of the ICE external structure. According to at least one example embodiment, the mounting structure is arranged on an intermediate portion of the fuel receiving conduit portion for attachment of the assembly to an outside of the ICE external structure.

According to at least one example embodiment, the mounting structure is adapted to fasten the intermediate portion of the fuel receiving conduit portion to the outside of the ICE external structure in a direction, which is substantially transverse in relation to a length direction of the single fuel feeding conduit portion.

According to a second aspect, there is provided an internal combustion engine (ICE) system for a vehicle. The ICE system comprises an ICE external structure and a fuel conduit connection assembly according to the first aspect of the present disclosure. Effects and features of this second aspect of the present disclosure are largely analogous to those described above in connection with the first aspect of the disclosure. Embodiments mentioned in relation to the first aspect of the present disclosure are largely compatible with the second aspect of the disclosure.

Typically, the mounting structure may be configured to be attached to the ICE external structure; the fuel receiving conduit portion may be connectable to an external fuel system component in the form of a plurality of corresponding fuel connections of a fuel pump system arranged outside of the ICE; and the single fuel feeding conduit portion may be connectable to an internal fuel system component in the form of a common rail located inside of the ICE.

As mentioned above, the ICE external structure may generally be a part of the ICE system. By way of example, the ICE external structure is a part of the ICE housing.

Optionally, the sealing arrangement may be arranged to seal against fluid leakage between an inside environment and an outside environment of the ICE when the assembly is attached to the ICE external structure. The mounting structure may be attached to an outside surface of the ICE external structure. By way of example, the sealing arrangement is arranged to seal against fluid leakage between the inside environment and the outside environment of the ICE when the assembly is attached to the ICE external structure by means of the mounting structure and at least one fastener. The sealing arrangement may be configured to be seated in an annular groove in the single fuel feeding conduit portion and compressed during assembly between the assembly and the ICE external structure, creating a seal at the interface. As such, the sealing arrangement provides a seal against a facing circumferential inner surface of a though hole of the ICE external structure.

According to at least one example embodiment, a part of the fuel conduit connection assembly extends completely through an opening in a wall portion of the ICE external structure. By way of example, a part of the single fuel feeding conduit portion extends completely through the opening in the wall portion of the ICE external structure. Typically, the opening in the wall portion of the ICE external structure may be the through hole of the ICE external structure. The through hole extends from an outer surface of the ICE external structure to an inner surface of the ICE external surface.

The mounting structure may be an integral portion of the fuel conduit connection assembly. In addition, the mounting structure may typically comprise a through hole for accommodating a fastener. In addition, or alternatively, the mounting structure may also comprise the fastener. By way of example, the fastener may be provided in the form of a bolt. The fastener may be insertable into the through hole of the mounting structure. In addition, the fastener may typically be adapted to engage with an engagement portion arranged on an outside surface of the ICE external structure. The fastener may comprise an outer threaded portion. Other types of fasteners are also conceivable as long as such fasteners are capable of attaching the mounting structure, and thus the fuel conduit connection assembly to the ICE external structure in a secure manner.

Thus, according to at least one example embodiment, the ICE external structure comprises an engagement portion. The engagement portion may be provided by a threaded portion for engaging with a corresponding threaded part of the bolt.

Other types of mounting structures and fasteners are also conceivable as long as such mounting structure and fasteners are configured to securely attach the fuel conduit connection assembly to an external part of the ICE, such as an external surface of a flywheel housing.

According to at least one example embodiment, the mounting structure and the fastener are configured to ensure that the fuel conduit connection assembly can be securely attached to the ICE external structure so as to handle various loads from any external and internal high pressure fuel components connectable to the fuel conduit connection assembly.

According to a third aspect, there is provided a vehicle comprising a fuel conduit connection assembly according to the first aspect of the present disclosure and/or an internal combustion engine system according the second aspect of the present disclosure. Effects and features of this third aspect of the present disclosure are largely analogous to those described above in connection with the first and second aspects of the disclosure. Embodiments mentioned in relation to the first and second aspects of the present disclosure are largely compatible with the third aspect of the disclosure.

Further advantages and advantageous features of the disclosure are disclosed in the following description and in the dependent claims. It should also be readily appreciated that different features may be combined to create embodiments other than those described in the following, without departing from the scope of the present disclosure.

The terminology used herein is for the purpose of describing particular examples only and is not intended to be limiting of the disclosure. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

### BRIEF DESCRIPTION OF THE DRAWINGS

The above, as well as additional objects, features and advantages of the present disclosure, will be better understood through the following illustrative and non-limiting detailed description of exemplary embodiments of the present disclosure, wherein:

FIG. 1 is a side view of a vehicle comprising an internal combustion engine system and a fuel conduit connection assembly according to an example embodiment of the present disclosure;

FIG. 2 is a schematic view of further components of the internal combustion engine system and the fuel conduit connection assembly according to an example embodiment of the present disclosure, in which the system can be incorporated into the ICE system of the vehicle illustrated in FIG. 1;

FIG. 3 is a perspective view of the fuel conduit connection assembly according to an example embodiment of the present disclosure, in which the fuel conduit connection assembly is in a dismounted state relative to an internal combustion engine of the ICE system;

FIG. 4 is a perspective view of the fuel conduit connection assembly according to an example embodiment of the present disclosure, in which the fuel conduit connection assembly is fixedly mounted to the internal combustion engine of the ICE system.

### DETAILED DESCRIPTION OF EXAMPLE EMBODIMENTS OF THE DISCLOSURE

The present disclosure will now be described more fully hereinafter with reference to the accompanying drawings, in which an exemplary embodiment of the disclosure is shown. The disclosure may, however, be embodied in many different forms and should not be construed as limited to the embodiment set forth herein; rather, the embodiment is provided for thoroughness and completeness. Like reference character refer to like elements throughout the description.

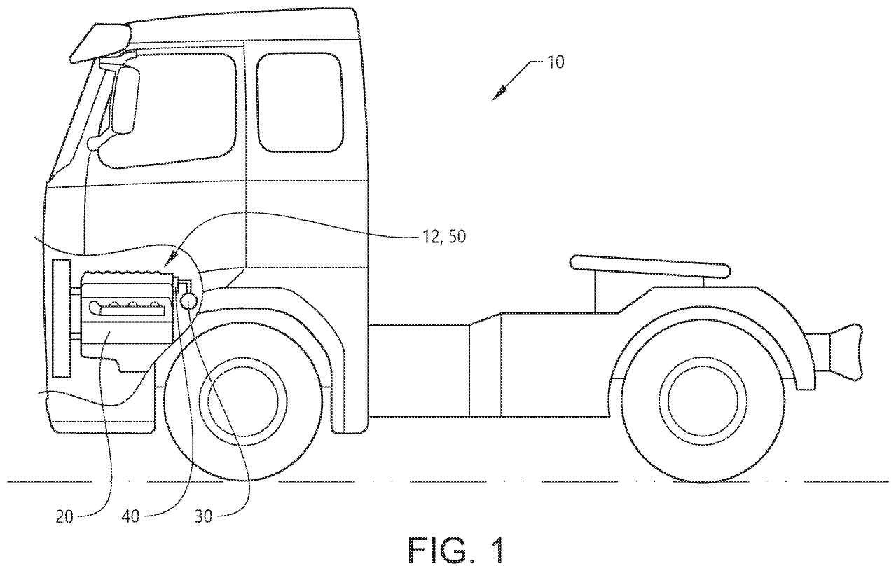

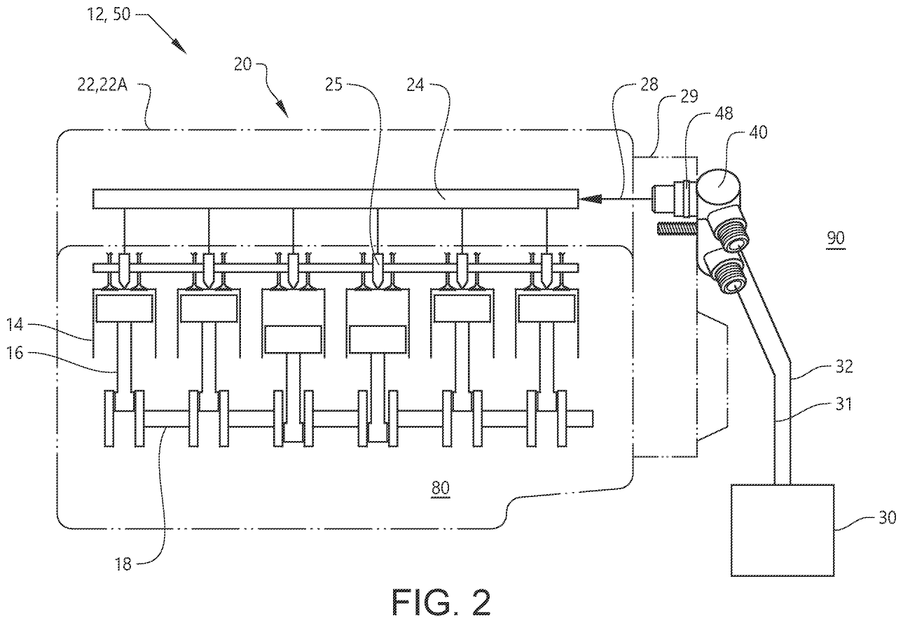

With particular reference to FIG. 1, there is provided a vehicle 10 in the form of a truck in a partly cut side view. The vehicle 10 comprises an internal combustion engine, ICE, system 12 for powering and driving the vehicle 10. The ICE system 12 in FIG. 1 also comprises an ICE 20 of a conventional type. By way of example, the ICE 20 is a diesel ICE. In a diesel ICE, the fuel in the form of diesel is supplied to the ICE from a fuel tank via a fuel system. In other examples, the fuel may be a gaseous fuel such as gasoline, hydrogen, natural gas, or the like. Hence, the ICE system 12 further comprises a fuel system 50, a fuel pump 30 and a fuel conduit connection assembly 40 according to an example embodiment of the disclosure, as will now be further described in relation to FIGS. 2 to 4.

Turning now to FIG. 2, there is depicted one example embodiment of the ICE system 12 for incorporation in a vehicle as described above in relation to FIG. 1. As is generally commonly known in the art of diesel ICE systems, the ICE 20 comprises a plurality of cylinders 14 operated to combust fuel, such as diesel, whereby the motion of pistons 16 reciprocating in the cylinders 14 is transmitted to a rotation movement of a crank shaft 18. The crank shaft 18 is further coupled to a transmission (not shown) for providing a torque to driving elements (not shown). In case of a heavy vehicle, such as a truck, the driving elements are wheels; however, the ICE 20 may also be used for other equipment such as construction equipment, marine applications, etc. The ICE system 12 further comprises an exhaust gas arrangement (not shown), which serves the purpose of conveying exhaust gases and recovering at least some of the energy in the exhaust gas flow to improve the performance of the ICE. The ICE system may also include additional engine components and system components.

The ICE system 12 here further comprises a common rail fuel injection system 24, as is commonly known in the art. As illustrated in FIG. 2, the common rail fuel injection system 24 defines a common fuel line (“common rail”) and is configured to supply diesel to the cylinders 16 by means of a number of injectors 25. Thus, the common rail fuel injection system 24 includes the plurality of injectors 25. The number of injectors 25 may be equal to the numbers of cylinders of the ICE 20. Here, the common rail fuel injection system 24 comprises six injectors 25, as illustrated in FIG. 2. The injectors 25 are arranged in fluid communication with a common fuel line of the common rail fuel injection system 24. As shown in FIG. 2, the common rail fuel injection system 24 is arranged inside the ICE 20.

The interior space of the ICE 20 defines a first environment 80, which generally corresponds to an ICE oil pressure environment. The ICE oil pressure environment 80 is generally defined by the inner surfaces of the ICE 20. Outside the ICE 20, a second environment 90 is present, which generally corresponds to an outer ICE atmospheric pressure environment. The boundary between the (first) interior ICE oil pressure environment 80 and the (second) outer ICE atmospheric pressure environment 90 is here defined by an ICE external structure 22. By way of example, the ICE external structure is here made up by the flywheel housing 29 and the engine block 22A. However, in other examples, the ICE external structure may be defined by a valve cover or the like. Still, in other examples, the ICE external structure may be completely or partly defined by any one of the flywheel housing 29, valve cover and the engine block 22A. The ICE external structure may likewise be defined by a combination of the flywheel housing 29, valve cover and the engine block 22A. Accordingly, the ICE external structure 22 may typically be a part of an ICE housing encompassing the ICE 20. In the following example, the flywheel housing 29 will be referred to as the ICE external structure 22 for reasons of simplifying the description of the example embodiments. It should be noted that the terms “inner”, “interior”, “inside” and “internal” are generally used in an interchangeable manner. Analogously, the terms “external”, “exterior”, “outside” and “outer” are generally used in an interchangeable manner. These terms may further be used in reference to a structure defining the external parts of the ICE housing, or a component thereof, such as the flywheel housing. In other words, the terms are used to define the relative position or location of a component relative to the ICE external structure. Sometimes, these terms may also be used to define a surface or a circumference of a component.

Outside the ICE 20, in the outer ICE atmospheric pressure environment 90, the fuel pump 30 is arranged, which is configured to pressurize the fuel to a high-pressure level. The fuel pump 30 is arranged in the fuel system 50 to transfer the high-pressure fuel to the injector bodies 25 arranged inside the ICE 20, as illustrated in FIG. 2. The fuel pump 30 is of a conventional type and thus not further described herein. In addition, the fuel pump 30 is in fluid communication with the fuel tank (not shown) for receiving fuel. As depicted in FIG. 2, the fuel pump 30 comprises two separate fuel channels 31, 32. That is, the fuel pump 30 has separate fuel channels 31, 32 extending from outlets of the fuel pump. The fuel channels 31, 32 may either be integral parts of the fuel pump 30 or provided as separate parts fluidly connected to outlets of the fuel pump 30. In this context, the fuel pump 30 is an ICE outer fuel system component, i.e. a fuel system component arranged outside the ICE external structure 22. Analogously, the fuel channels 31, 32 are also ICE outer fuel system components, i.e. fuel system components arranged outside the ICE external structure 22.

In a similar vein, as illustrated in FIG. 2, the common rail fuel injection system 24 is an ICE interior fuel system component, i.e. a fuel system component arranged inside the ICE external structure 22. Typically, although strictly not required, the common rail fuel injection system 24 has a fuel receiving conduit 28. The fuel receiving conduit 28 may either be an integral part of the common rail fuel injection system 24 or provided as a separate part fluidly connected to the common rail fuel injection system 24. The fuel receiving conduit 28 is also completely arranged inside the ICE 20. Hence, the fuel receiving conduit 28 is also an ICE interior fuel system component, i.e. a fuel system component arranged inside the ICE external structure 22.

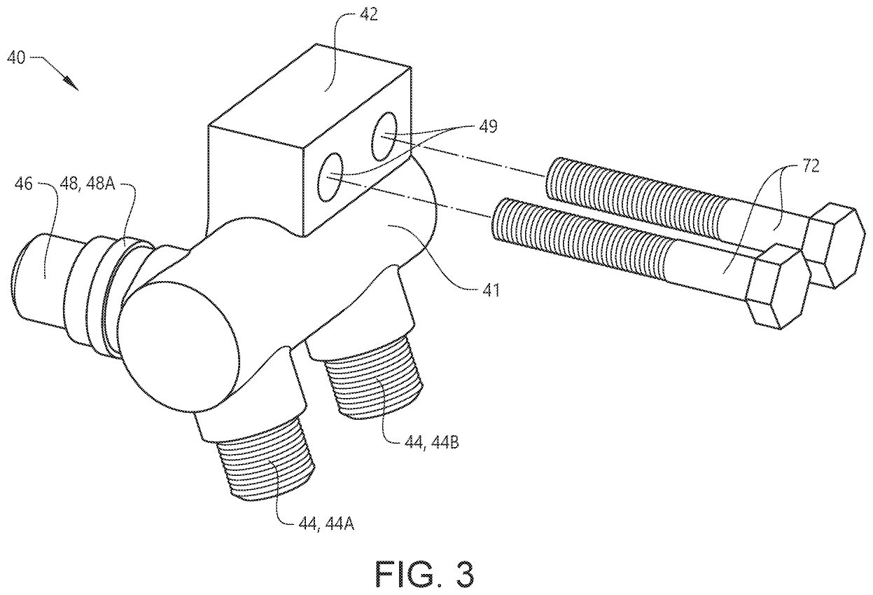

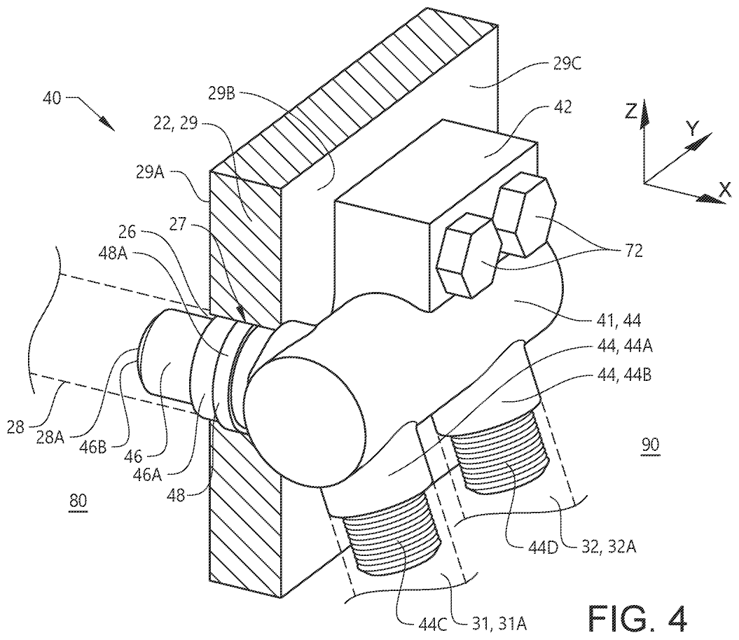

Furthermore, the fuel pump 30 is in fluid communication with the common rail fuel injection system 24 by means of the fuel conduit connection assembly 40. By way of example, the fuel conduit connection assembly 40 is arranged and configured to interconnect the ICE outer fuel components (fuel channels) 31, 32 with the ICE inner fuel component (fuel receiving conduit) 28. Further details of the fuel conduit connection assembly 40 will now be described in relation to FIGS. 2 to 4, which illustrates one example embodiment of the fuel conduit connection assembly 40. For ease of reference, the fuel conduit connection assembly 40 may sometimes simply be denoted as the assembly. FIG. 3 illustrates the fuel conduit connection assembly 40 in a dismounted state relative to the ICE external structure 22, while in FIG. 4 the fuel conduit connection assembly 40 is fixedly mounted to the ICE external structure 22.

The assembly 40 will now be further described in an orientation to the ICE 20, as illustrated in e.g. FIG. 4. However, the orientation of the assembly 40 as depicted in FIG. 4 is merely used as an example for ease of understanding the attachment of the assembly 40 to the ICE 20, and other attachment arrangements and orientations of the assembly 40 to the ICE 20 may be conceivable. As indicated in e.g. FIG. 4, the assembly 40 has an extension in a longitudinal direction X, an extension in a transverse direction Y and an extension in a vertical direction Z. In this coordinate system, the X-direction is parallel to the main extension of the common fuel line 28, the Y-direction is parallel to the transvers extension of the ICE 20 and the Z-direction is parallel to the vertical direction of the ICE 20.

As illustrated in FIG. 2, the fuel conduit connection assembly 40 is arranged and configured to interconnect the fuel channels 31, 32 arranged outside the flywheel housing 29 (ICE external structure) with the fuel receiving conduit 28 of the common rail fuel injection system 24, which is arranged on the other side, i.e. inside, of the flywheel housing 29.

As illustrated in FIGS. 2 to 4, the fuel conduit connection assembly 40 comprises a mounting structure 42 for fastening a portion of the assembly 40 to the ICE external structure, here in the form of the flywheel housing 29. The mounting structure 42 is here provided in the form of an integral portion of the assembly 40 and defines a through hole 49 for accommodating a fastener 72 such as a bolt. In FIG. 3, the assembly 40 is illustrated with a pair of bolts 72 insertable into a pair of corresponding through holes 49 of the mounting structure 42. The bolts are insertable across the corresponding through holes and adapted to engage with an engagement portion 29C (FIG. 4) arranged on an outside surface 29B (FIG. 4) of the flywheel housing 29. The engagement portion may be provided by a pair of threaded portions (not shown) for engaging with corresponding threaded parts of the bolts. However, other types of mounting structures and fasteners are also conceivable as long as such mounting structure and fasteners are configured to securely attach the fuel conduit connection assembly 40 to a part of the ICE 20, such as the external portion of the flywheel housing 29. The mounting structure 42 and the fastener 72 are configured to ensure that the fuel conduit connection assembly 40 is securely attached to the outside of the flywheel housing 29 so as to handle various loads from the external and internal high pressure fuel components 28, 31, 32 etc.

In addition, the assembly 40 comprises a fuel receiving conduit portion 44, as illustrated in e.g. FIGS. 2 to 4. The fuel receiving conduit portion 44 is configured to transport a high-pressure fuel of about between 200 to 3500 bar. The fuel receiving conduit portion 44 comprises a plurality of inlet fuel duct connections 44A, 44B. Each one of the inlet fuel duct connections 44A, 44B is configured to connect to a corresponding fuel channel 31, 32 of the fuel pump 30, which is arranged outside the flywheel housing 29. Also, each one of the inlet fuel duct connections is adapted to contain and transfer fuel having a pressure in the range of 200 to 3500 bar, in operation.

Moreover, as illustrated in e.g. FIGS. 2 to 4, the assembly 40 comprises a single fuel feeding conduit portion 46 for connecting to the fuel receiving conduit 28 of the common rail fuel injection system 24, which is arranged on the other side, i.e. inside, of the flywheel housing 29. The single fuel feeding conduit portion 46 is configured to transport a high-pressure fuel. Hence, the single fuel feeding conduit portion is here adapted to contain and transfer fuel having a pressure in the range of 200 to 3500 bar, in operation.

Optionally, as illustrated in e.g. FIGS. 2 to 4, the assembly 40 further comprises an portion 41 adapted to align a plurality of fuel flow receiving channels formed by the inlet fuel duct connections 44A, 44B into a single fuel feed channel of the single fuel feeding conduit portion 46. The portion is here provided in the form of an intermediate portion. By way of example, the intermediate portion 41 is an integral part of the assembly 40 that is arranged in-between the fuel receiving conduit portion 44 and the single fuel feeding conduit portion 46. In the example illustrated in FIGS. 2 to 4, however, the intermediate portion 41 is an integral portion of the fuel receiving portion 44. Moreover, the mounting structure 42 is here arranged on the intermediate portion 41 of the fuel receiving conduit portion 44 for attachment to the outside of the ICE external structure, which in FIGS. 3 to 4 is the outer surface 29B of the flywheel housing 29. As depicted in FIGS. 3 to 4, the mounting structure 42 is arranged on the assembly 40 and adapted to fasten the intermediate portion 41 of the fuel receiving conduit portion 44 to the outer surface 29B of the flywheel housing 29 in the transverse direction Y, so that a substantial part of the assembly 40 located outside the flywheel housing is arranged transverse in relation to an axial direction of the single fuel feeding conduit portion 46, which here corresponds to the longitudinal direction X, as depicted in e.g. FIG. 4. As such, the assembly 40 is arranged in a particularly user-friendly configuration in relation to the ICE 20.

Turning again to FIGS. 2 to 4, the assembly 40 also comprises a sealing arrangement 48. The sealing arrangement 48 is arranged on an outer circumferential surface of the assembly 40. Moreover, the sealing arrangement 48 is configured to provide sealing between the first environment 80 and the second environment 90 when the assembly is attached to the flywheel housing 29 by means of the mounting structure 42 and the fasteners 72. In this arrangement, the assembly 40 is arranged and attached in a mounted state with the flywheel housing 29, as illustrated in FIG. 2, and in particular in FIG. 4. As may be gleaned from FIG. 4, the ICE external structure 22 comprises a through hole 26. Hence, in this example, the flywheel housing 29 comprises the through hole 26, extending from the outer surface 29B to an inner surface 29A of the flywheel housing 29. In addition, the single fuel feeding conduit portion 46 here comprises a circumferential surface region 46A, having an extension that is adapted to match with a depth of the through hole 26 of the flywheel housing 29. That is, the longitudinal extension of the circumferential surface region 46A essentially corresponds to the extension of the through hole 26, as defined by the distance between the outer surface 29B and the inner surface 29A of the flywheel housing 29.

As illustrated in FIGS. 3 and 4, the sealing arrangement 48 is arranged about the circumferential surface region 46A so as to create a sealing of the assembly 40 with the flywheel housing 20, thereby providing a sealing between the first environment 80 and the second environment 90. More specifically, the sealing arrangement 48 is configured to be seated in an annular groove in the single fuel feeding conduit portion 46 and compressed during assembly between the assembly 40 and the flywheel housing 29, creating a seal at the interface. As such, the sealing arrangement 48 provides a seal against a facing circumferential inner surface 27 of the though hole 26 of the flywheel housing 20, as illustrated in in FIG. 4.

By way of example, the sealing arrangement 48 is a conventional O-ring. The O-ring is thus arranged about the single fuel feeding conduit portion 46, as illustrated in FIG. 4. Accordingly, the O-ring comprises the sealing surface 48A for sealing between the first environment 80 and the second environment 90. That is, the O-ring provides a sealing in combination with the facing circumferential inner surface 27 of the though hole 26 of the flywheel housing 29. To this end, it should be readily appreciated that the dimension of the O-ring matches the diameter of the through hole 26, as is ordinarily known in the field of sealing arrangements with O-rings.

Typically, although strictly not required, the diameter of the circumferential surface region 46A may be slightly bigger than the diameter of the other part of the single fuel feeding conduit portion 46, as illustrated in FIGS. 3 and 4. However, the single fuel feeding conduit portion 46 may also be designed in other ways as long as the sealing arrangement 48 can provide an adequate sealing between the environments 80 and 90 when the assembly is attached to the flywheel housing by means of the mounting structure 42. To this end, it should also be readily appreciated that the relative positions of the mounting structure 42, the sealing arrangement 48 and the single fuel feeding conduit portion 46 should be designed so as to match the positions of the through hole 26 and the engagement of the flywheel housing 29, as also depicted in FIGS. 3 and 4.

Further, while the sealing arrangement 48 in the form of the O-ring here contains a single sealing surface 48A, it should be readily appreciated that the sealing arrangement 48 may define or contain a number of sealing surfaces, collectively defining the sealing.

As mentioned above, the assembly 40 is generally configured to be dismounted from the fuel connection of the inside ICE fuel system component and the fuel connections from the outside ICE fuel system components. Therefore, the single fuel feeding conduit portion 46 and each one of the plurality of inlet fuel duct connections 44A and 44B are here configured to provide detachable fluid connections. In this manner, it becomes possible to access the assembly 40 from both environments 80 and 90. While the detachable configurations of the parts can be provided in several different ways, the parts may for example each include a threaded portion adapted to engage with a corresponding threaded portion of one of the fuel components.

Accordingly, each one of the plurality of inlet fuel duct connections 44A and 44B comprises corresponding end portions 44C, 44D, respectively. In addition, each one of the corresponding end portions 44C, 44D is adapted to detachably connect to corresponding fuel connections of the plurality of corresponding fuel channels 31, 32. By way of example, each one of the end portions is provided in the form of a threaded end portion, as illustrated in e.g. FIGS. 3 and 4. Analogously, each one of the fuel connections of the plurality of corresponding fuel channels 31, 32 is provided in the form of a corresponding threaded end portion 31A, 32A configured to engage with the corresponding threaded end portions 44C, 44D.

In addition, or alternatively, the single fuel feeding conduit portion 46 comprises an end portion 46B adapted to detachably connect to a corresponding fuel connection of the inside ICE fuel system component. By way of example, the end portion of the single fuel feeding conduit portion is provided in the form of a threaded end portion. Analogously, the corresponding fuel connection of the inside ICE fuel system component, 28 in FIG. 4, is provided in the form of a corresponding threaded end portion 28A configured to engage with the threaded end portion 46B.

To sum up, the disclosure also relates to the ICE system 12 for the vehicle 10, as illustrated in e.g. FIG. 1, the ICE system 12 comprising the fuel conduit connection assembly 40 according to any one of example embodiments described in relation to the FIGS. 1 to 4. In particular, the assembly 40 comprises the mounting structure 42 configured to form an attachment with the ICE external structure 22, 29 of the ICE system 12; the fuel receiving conduit portion 44 being configured to connect to an external fuel system component in the form of the plurality of corresponding fuel connections 31, 32 of the fuel pump system 30 arranged outside of the ICE 20; and the single fuel feeding conduit portion 46 being configured to connect to the internal fuel system component 28 in the form of the common rail 24 located inside of the ICE. Moreover, the sealing arrangement 48 is arranged to seal against fluid leakage between the inside environment 80 and the outside environment of the ICE 90. By way of example, the assembly 40 is sealingly arranged through the flywheel housing 29 by means of the O-ring.

Hence, a part of the fuel conduit connection assembly 40 extends completely through the opening 26 in the wall portion 29 of the ICE 20. By way of example, a part 46A of the single fuel feeding conduit portion 46 extends completely through the opening 26 in the wall portion 29 of the ICE 20. The disclosure also relates to the vehicle comprising the fuel conduit connection assembly according to any of one of the example embodiments above and/or an internal combustion engine system according to any one of the example embodiments above.

As mentioned above, the present disclosure provides a simple and compact device for providing a user-friendly and robust interface connection for supplying fuel from the outside of the ICE to the inside of ICE. In particular, the assembly 40 provides for transporting a high-pressure fuel of e.g. about 3000bar from the pump 30 arranged outside the ICE to the common rail system arranged inside of the ICE. The assembly is configured to be attached the ICE external structure, such as the flywheel housing, an engine block or a valve cover of the ICE, and further configured to extend therethrough in a through hole 26 of the ICE external structure, wherein the assembly 40 is configured to align at least two separate flow channels 31, 32 from the pump 30 into one single feed connection of the common rail system. Further, by the provision that the assembly 40 is detachably connectable to the inside and outside fuel components by the fuel receiving conduit portion and the single fuel feeding conduit portion, respectively, it becomes possible to allow for disconnection of the connecting components from both environments 80 and 90, individually. Moreover, the mounting structure 42 and the sealing arrangement 40 may further allow for individual movement between the interface components to the assembly 40.

It is to be understood that the present disclosure is not limited to the embodiments described above and illustrated in the drawings; rather, the skilled person will recognize that many changes and modifications may be made within the scope of the appended claims. By way of example, the mounting structure 42 of the fuel conduit connection assembly 40 may likewise be securely attached on an outside of another ICE component, such as any one of the engine block 22A and the valve cover, or the like.

1. A fuel conduit connection assembly for interconnecting fuel system components of an internal combustion engine system, wherein the fuel conduit connection assembly comprises:
a mounting structure for fastening a portion of the assembly to an ICE external structure;
a fuel receiving conduit portion having a plurality of inlet fuel duct connections for connecting to a plurality of corresponding fuel channels of a fuel system component outside the ICE external structure, respectively;
a single fuel feeding conduit portion for connecting to a fuel system component internal the ICE external structure; and
a sealing arrangement arranged on an outer circumferential surface of the assembly and configured to provide sealing between a first environment and a second environment in an assembled state with the ICE external structure.

2. The fuel conduit connection assembly according to claim 1, wherein each one of the plurality of inlet fuel duct connections comprises a corresponding end portion, respectively, each one of the corresponding end portions being adapted to detachably connect to a corresponding fuel connection of the plurality of corresponding fuel channels.

3. The fuel conduit connection assembly according to claim 2, wherein each one of the end portions is provided in the form of a threaded end portion.

4. The fuel conduit connection assembly according to claim 1, wherein the single fuel feeding conduit portion comprises an end portion adapted to detachably connect to a corresponding fuel connection of the internal ICE fuel system component.

5. The fuel conduit connection assembly according to claim 4, wherein the end portion of the single fuel feeding conduit portion is provided in the form of a threaded end portion.

6. The fuel conduit connection assembly according to claim 1, wherein the fuel receiving conduit portion and the single fuel feeding conduit portion are configured to transport a high-pressure fuel.

7. The fuel conduit connection assembly according to claim 1, wherein the sealing arrangement comprises at least an O-ring arranged about the single fuel feeding conduit portion.

8. The fuel conduit connection assembly according to claim 1, further comprising a portion adapted to align a plurality of fuel flow receiving channels formed by the inlet fuel duct connections into a single fuel feed channel of the single fuel feeding conduit portion.

9. The fuel conduit connection assembly according to claim 1, wherein the mounting structure is arranged on an intermediate portion of the fuel receiving conduit portion for attachment of the assembly to an outside of the ICE external structure.

10. The fuel conduit connection assembly according to claim 9, wherein the mounting structure is adapted to fasten the intermediate portion of the fuel receiving conduit portion to the outside of the ICE external structure in a direction, which is substantially transverse in relation to a length direction of the single fuel feeding conduit portion.

11. An internal combustion engine, ICE, system for a vehicle, comprising an ICE external structure and a fuel conduit connection assembly according to claim 1, wherein the mounting structure is configured to be attached to the ICE external structure; the fuel receiving conduit portion is connectable to an external fuel system component in the form of a plurality of corresponding fuel connections of a fuel pump system arranged outside of the ICE; and the single fuel feeding conduit portion is connectable to an internal fuel system component in the form of a common rail located inside of the ICE.

12. The internal combustion engine system according to claim 11, wherein the sealing arrangement is arranged to seal against fluid leakage between an inside environment and an outside environment of the ICE when the assembly is attached to the ICE external structure.

13. The internal combustion engine system according to claim 1, wherein a part of the fuel conduit connection assembly extends completely through an opening in a wall portion of the ICE external structure.

14. The internal combustion engine system according to claim 13, wherein a part of the single fuel feeding conduit portion extends completely through the opening in the wall portion of the ICE external structure.

15. A vehicle comprising fuel conduit connection assembly according to claim 1 and/or an internal combustion engine system.
